(19) United States
(12) Patent Application Publication
(10) Pub. No.: US 2003/0104838 A1
(43) Pub. Date: Jun. 5, 2003

(54) Voice call originating method in radio terminal

(75) Inventor: Joo-Bong Lee, Kyungki-Do (KR)

Correspondence Address: FLESHNER & KIM, LLP, P.O. BOX 221200, CHANTILLY, VA, 20153, US

(73) Assignee: LG ELECTRONICS INC.

(21) Appl. No.: 10/071,092

(22) Filed: Feb. 11, 2002

(30) Foreign Application Priority Data
Dec. 4, 2001 (KR) 76323/2001

(51) Int. Cl. H04M 1/00

(52) U.S. Cl. 455/564; 455/567

(57) ABSTRACT

A voice call originating method in a radio terminal, by which a voice call origination can be immediately made to a telephone number included in a message during identifying the message on the radio terminal, comprises: a step of receiving the message; a step of identifying the telephone number included in the message; and a step of designating the identified telephone number and performing a voice call origination, whereby the voice call can be made by designating directly the telephone number included in the message without taking an additional note.

### BACKGROUND OF THE INVENTION

1. Field of the Invention

The present invention relates to a radio terminal, and particularly, to a voice call originating method in the radio terminal by which a voice call originating can be immediately tried to a telephone number which is included in a message when a user identifies the message on the radio terminal.

2. Description of the Background Art

Recently, radio terminals are widely distributed by a development in communication techniques, and these radio terminals includes various functions such as memory, multi media support, internet communication in order to strengthen their competitiveness.

Especially, the internet communication using the radio terminal has advantages that the user can transmit/receive information anywhere without using a terminal connected to wired communication cable such as personal computer, and that information exchange can be made easily. FIG. 1 is a view showing an SMS (Short Message Service) transmission system in a general radio terminal.

As shown therein, the SMS transmission system comprises: a radio terminal 1 which is served personal communication such as the SMS; a base station 2 for transmitting/receiving a message and status information with the radio terminal 1; a controller 3 for controlling and managing a plurality of base stations 2, controlling wired/radio links during origination/termination call processing, and performing all functions needed to process a radio call such as transcoding, hand off control; an exchanger 4 for performing as a switch by communicating with the other networks, and at the same time, performing all functions needed to call processing in a mobile communication system and data exchange; and a short message service center 5 for providing a short message between the radio terminal 1 and the exchanger 4, or between an outer device and the exchanger 4. Also, the radio terminal 1 is connected to a PSTN (Public Switched Telephone Network) through an exchanger 4.

FIG. 2 is a flow chart showing a voice call originating method in a radio terminal according to the conventional art.

As shown therein, a short message outputted from the short message service center 5 is transmitted to the exchanger 4 which finds a state and location information of the radio terminal and controls corresponding area, and then the short message is transmitted to the radio terminal 1 through the controller 3 and the base station 2 (S11). Therefore, the user identifies the short message transmitted to the radio terminal 1 (S12), and after that, makes a voice call.

That is, the user takes note of a telephone included in the message with a pen or inputs the telephone number into another communication terminal (S13). In addition, the user inputs the written telephone number on key pad of the radio terminal 1 manually, and after that, the user makes a voice call to the telephone number included in the message by pushing a send key (S14).

However, according to the conventional voice call originating method in the radio terminal described above, the user should take an additional note of a telephone number which is included in the short message, in case that the user wants to make a call to the telephone number during reading the short message through the radio terminal.

### SUMMARY OF THE INVENTION

Therefore, an object of the present invention is to provide a voice call originating method in a radio terminal by which a voice call origination can be made immediately when an origination request to a telephone number included in a message is generated in the radio terminal.

To achieve the object of the present invention, as embodied and broadly described herein, there is provided a voice call originating method in a radio terminal comprising: a step of receiving a message; a step of identifying a telephone number included in the message; and a performing a voice call origination by directly designating the identified telephone number.

Also, to achieve the object of the present invention, there is provided a voice call originating method in a radio terminal comprising: a step of receiving a message through the radio terminal; a step of identifying a telephone number included in the transmitted message; a step of designating the identified telephone number using a browsing key on the radio terminal; a step of deciding whether or not the designated telephone number should be edited; and a step of performing a voice call origination to the designated telephone number.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing an SMS (Short Message Service) transmission system in a general radio terminal;

FIG. 2 is a flow chart showing a voice call originating method in a radio terminal according to the conventional art;

FIG. 3 is a view showing inner structure of the general radio terminal; and

FIG. 4 is a flow chart showing a voice call originating method in the radio terminal according to the present invention.

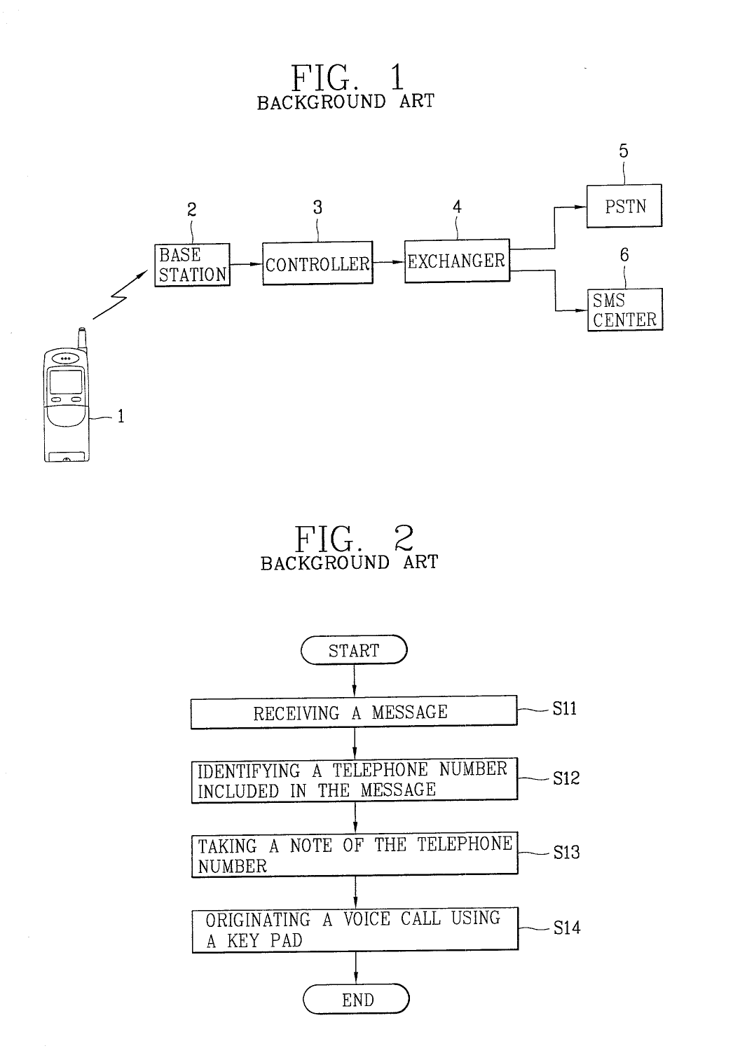

### DETAILED DESCRIPTION OF THE PREFERRED EMBODIMENTS

Reference will now be made in detail to the preferred embodiments of the present invention, examples of which are illustrated in the accompanying drawings.

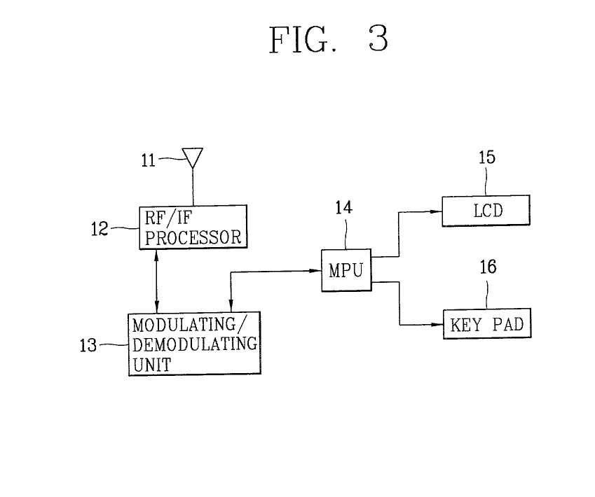

FIG. 3 is a block diagram showing an inner structure of a general radio terminal. As shown therein, the general radio terminal comprises: an antenna 11; an RF/IF (Radio Frequency/Intermediate Frequency) processor 12; a modulating/demodulating unit 13; an MPU (Microprocessor Unit) 14; an LCD (Liquid Crystal Display) 15; and a keypad 16.

The RF/IF processor 12 transforms an RF signal inputted through the antenna 11 into an IF signal, and then applies the signal to the modulating/demodulating unit 13. In addition, the RF/IF processor 12 transforms the modulated signal applied from the modulating/demodulating unit 13 into the RF signal, and transmits it through the antenna 11. The modulating/demodulating unit 13 demodulates the IF signal applied from the RF/IF processor 12 and outputs the signal, and modulates the signal applied from the system and outputs the signal to the RF/IF processor 12. The MPU 14 controls operations of the modulating/demodulating unit 13 and of the LCD 15, and at the same time, performs all control operations. The LCD 15 displays all information which is required to make a call so as to identify visually according to the controls of the MPU 14, and the key pad 16 includes keys for inputting a telephone number, and keys for selecting various functions by which corresponding key input information is inputted to the MPU 15.

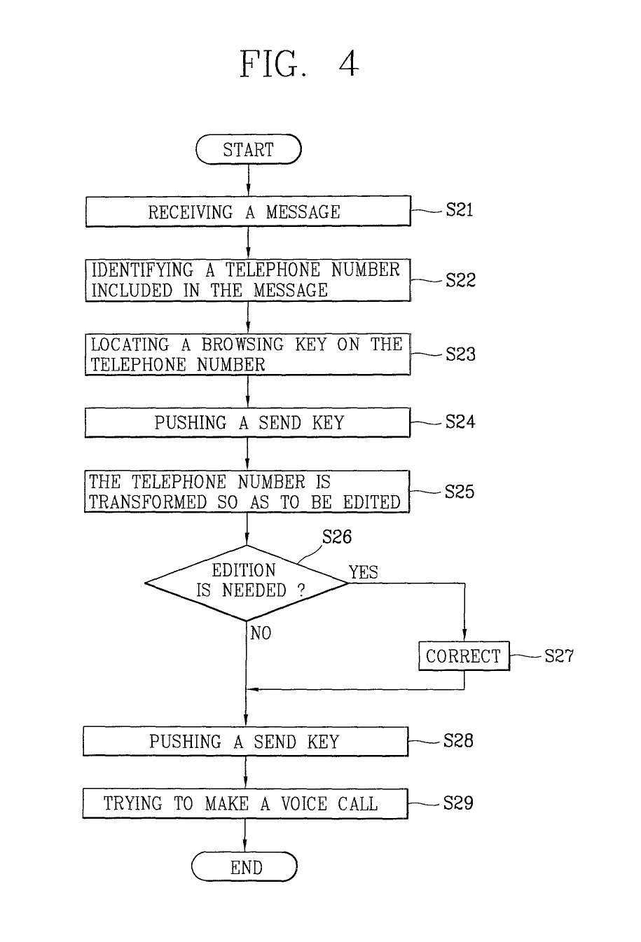

FIG. 4 is a view showing a voice call originating method in a radio terminal according to the present invention.

As shown therein, an SMS signal inputted through the antenna 11 is transformed into an IF signal through the RF/IF processor 12, demodulated in the modulating/demodulating unit 13, and after that, outputted on the LCD 15 of the radio terminal according to the controlling signal of the MPU 14, and therefore, the radio terminal receives the message (S21). The user identifies the transmitted message through the radio terminal (S22), and then the user moves the browsing key which is designated in the radio terminal to the telephone number included in the message if the user wants to make a call to the telephone number (S23). In addition, the user pushes the send key of the radio terminal in a state that the browsing key is located on the telephone number and the telephone number is designated (S24).

The browsing key means a navigator key which is able to move a cursor displayed on the LCD 15 of the radio terminal, and a direction key which is able to make the cursor move to upward, downward, left, and right directions in a general radio terminal is a kind of browsing key.

At that time, when the user pushes the send key in the state that the telephone number is designated, the paused telephone number is displayed on the LCD 15 of the radio terminal and changed to a state that the telephone number is able to be edited (S25). The user decides whether or not the telephone number should be edited (S26). Then, the user corrects the telephone number using the key pad 16 of the radio terminal (S27) and pushes the send key if the telephone number should be edited, and pushes directly the send key if there is no need to edit the telephone number (S28). Therefore, the radio terminal performs the voice call origination to the telephone number included in the message according to the operation of the send key (S29).

As described above, according to the voice call originating method in the radio terminal of the present invention, the voice call origination can be made immediately by selecting the telephone number included in the transmitted message, whereby the user does not need to take a note of the telephone number.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A voice call originating method in a radio terminal comprising:
a step of receiving a message;
a step of identifying a telephone number included in the message; and
a step of designating directly the identified telephone number and performing a voice call origination.

2. The method of claim 1, wherein the step of performing the voice call origination comprises:
a step of designating the telephone number included in the message by operating a browsing key on the radio terminal; and
a step of originating the voice call to the designated telephone number.

3. The method of claim 2, wherein the browsing key is a navigator key which is able to move a cursor displayed on the radio terminal to upward, downward, left and right directions.

4. The method of claim 2 further comprising a step of deciding whether or not the designated telephone number should be edited.

5. A voice call originating method in a radio terminal comprising:
a step of receiving a message through the radio terminal;
a step of identifying a telephone number included in the transmitted message;
a step of designating the identified telephone number using a browsing key on the radio terminal;
a step of deciding whether or not the designated telephone number should be edited; and
a step of performing a voice call origination to the designated telephone number.

6. The method of claim 5, wherein the designated telephone number is corrected by using a key pad of the radio terminal in case that the telephone number needs to be edited.

7. The method of claim 5, wherein the designation of the telephone number is made by locating the browsing key designated in the radio terminal and pushing a send key.

8. The method of claim 5, wherein the voice call transmission step is performed by pushing the send key on the radio terminal.
